(19) United States
(12) Patent Application Publication
(10) Pub. No.: US 2009/0121952 A1
(43) Pub. Date: May 14, 2009

(54) Slot Antenna

(75) Inventors: Yuzo Shibuya, Kanagawa (JP); Masayuki Sugano, Tokyo (JP)

Correspondence Address: GIBSON & DERNIER L.L.P., 900 ROUTE 9 NORTH, SUITE 504, WOODBRIDGE, NJ, 07095, US

(73) Assignee: JAPAN RADIO CO., LTD., Tokyo (JP)

(21) Appl. No.: 12/296,763

(22) PCT Filed: Mar. 6, 2007
(86) PCT No.: PCT/JP2007/000172

§ 371 Date: Dec. 5, 2008

(30) Foreign Application Priority Data
Apr. 12, 2006 (JP) 2006-110265

(51) Int. Cl. H01Q 13/10

(52) U.S. Cl. 343/767

(57) ABSTRACT

Impedance matching is achieved in a waveguide of a slot antenna, which is provided with an input waveguide that is fed power via an aperture plane; a stairway structure is provided in the input waveguide; the structure creates a step going upward toward a surface provided with a slot; the step difference and height of the step going upward are adjusted so that the impedance at a plane above the step and the impedance at the aperture plane match.

### TECHNICAL FIELD

The present invention relates to an antenna technology and, more particularly, to a slot antenna comprising a waveguide provided with a slot.

### BACKGROUND ART

Slot antennas having a waveguide provided with a slot for radiating electromagnetic waves are used for ship radars and other special-purpose radars. A slot antenna guides electromagnetic waves entering an aperture plane to the waveguide and radiates electromagnetic waves from the slot. It is desirable to achieve impedance matching in the aperture plane so that the aperture plane has a characteristic whereby the entering electromagnetic waves are totally absorbed so as not produce any reflected waves, i.e., a characteristic of a reflection-free terminal. Achieving a characteristic of a reflection-free terminal is difficult due to the frequency of electromagnetic waves, shape of the waveguide, material of the waveguide, etc. In the related art, a waveguide window or a post is provided in a waveguide in order to achieve impedance matching in a slot antenna (see, for example, a non-patent document No. 1).

[non-patent document No. 1] Masamitsu Nakajima, Microwave engineering, Morikita Shuppan, pp. 115-116.

### DISCLOSURE OF THE INVENTION

### Problem to be Solved by the Invention

In this back ground, we have become aware of the following problem. More specifically, a waveguide window or a post requires precision working and assembly of parts in manufacturing an antenna. In association with this, the manufacturing cost and yield are affected.

The present invention addresses this problem and its general purpose is to provide a slot antenna in which impedance matching is achieved using a simple structure.

### Means to Solve the Problem

A slot antenna according to at least one embodiment of the present invention comprises: a radiation waveguide operative to radiate electromagnetic waves from a slot provided in a flush surface thereof; and an input waveguide coupled at one end to a surface opposite to the flush surface and receiving entering electromagnetic waves through an aperture separate from the coupling end. The height of the input waveguide is narrowed from the aperture toward the coupling end by a stairway structure, and the step difference of the stairway structure is adjusted so that the impedance at the aperture and the impedance at the coupling end match.

The phrase “the impedance at the aperture and the impedance at the coupling end match” encompasses ensuring the impedance at the aperture matches the impedance at the coupling end by adjusting the height of the step difference and adjusting the impedance occurring at the cross section of the waveguide above the step difference accordingly. The phrase “the height of the waveguide” refers to the breadth between two of those surfaces forming the input waveguide that are parallel with the flush surface in which the slots are arranged. According to the embodiment, the impedance at the aperture is matched to the impedance at the coupling end by configuring the interior of input waveguide to have a step difference so that the width of the waveguide is decreased by a stairway structure from the aperture toward the coupling end.

The stairway structure may be formed of a plurality of steps, and the length of each of the plurality of steps from an end facing the aperture toward the coupling end may be adjusted so that the impedance at the aperture and the impedance at the coupling end match. According to the embodiment, the amount of phase change in the waveguide is adjusted by adjusting the length of each of a plurality of steps from an end thereof facing the aperture toward the coupling end. In this way, it is ensured that the impedance at the aperture matches the impedance at the coupling end.

There may further be provided a branch waveguide lying between the radiation waveguide and the input waveguide and operative to guide electromagnetic waves entering the input waveguide to the radiation waveguide. The step difference of the stairway structure in the input waveguide may be formed by the height of the branch waveguide. According to the embodiment, the impedance at the aperture and the impedance at the coupling end are matched efficiently by using the direction of height of the branch waveguide as the step difference of a stairway structure in the input waveguide.

Optional combinations of the aforementioned constituting elements, and implementations of the invention in the form of methods, apparatuses, systems, recording mediums and computer programs may also be practiced as additional modes of the present invention.

### ADVANTAGE OF THE PRESENT INVENTION

According to the present invention, a slot antenna in which impedance matching is achieved using a simple structure is provided.

### BRIEF DESCRIPTION OF THE DRAWINGS

FIG. 1 is a first perspective view showing an exemplary structure of a slot antenna according to an embodiment of the present invention;

FIG. 2 is a second perspective view showing an exemplary structure of the slot antenna of FIG. 1;

FIG. 3 is a third schematic view schematically showing the first slot antenna of FIG. 2;

FIG. 4A is a first schematic view schematically showing the internal structure of the second slot antenna according to a variation of the present invention;

FIG. 4B is a second schematic view schematically showing the internal structure of the second slot antenna according to a variation of the present invention;

FIG. 4C is a third schematic view schematically showing the internal structure of the second slot antenna according to a variation of the present invention; and

FIG. 4D is a fourth schematic view schematically showing the internal structure of the second slot antenna according to a variation of the present invention.

### DESCRIPTION OF THE REFERENCE NUMERALS

10 input waveguide, 12 input and output port, 14 entrance aperture plane, 16 step difference aperture plane, 18 step surface, 20 branch waveguide, 22 first waveguide slot, 24 second waveguide slot, 30 radiation waveguide, 32 slotted surface, 34 radiating slots, 36 opposite surface, 50 step, 52 first step, 54 second step, 70 first step surface, 72 second step surface, 100 slot antenna

### BEST MODE FOR CARRYING OUT THE INVENTION

A summary will be given before describing an embodiment of the present invention. The embodiment of the present invention relates to a slot antenna. The slot antenna according to the embodiment comprises a waveguide provided with a slot for radiating electromagnetic waves. Electromagnetic waves enter the aperture plane of the waveguide, guided through the waveguide, and radiated from the slot. If impedance matching is not achieved in the aperture plane, the entering electromagnetic waves are partly reflected. Therefore, it is desirable that impedance matching be achieved in the waveguide. According to the embodiment, reflected waves are reduced by achieving impedance matching with respect to the aperture plane by providing a stairway structure in the waveguide. In this way, the energy of entering waves is efficiently turned into the energy of radiated waves. The details will follow.

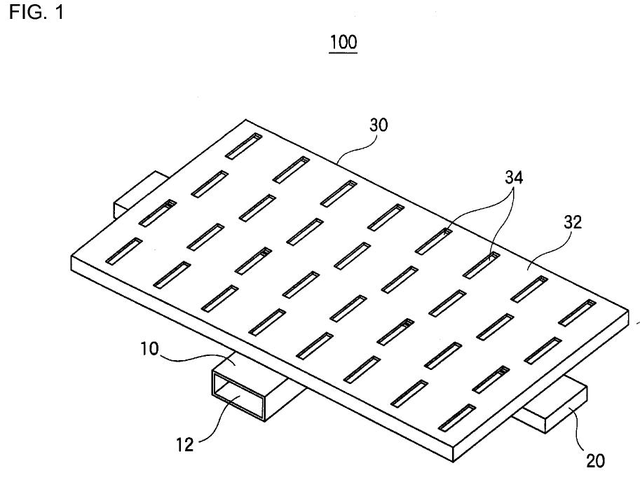

FIG. 1 is a first perspective view showing an exemplary structure of a slot antenna 100 according to the embodiment. The slot antenna 100 comprises an input waveguide 10, a branch waveguide 20, and a radiation waveguide 30. The input waveguide 10, the branch waveguide 20, and the radiation waveguide 30 are coupled to each other. The input waveguide 10 is provided with an input and output port 12 where electromagnetic waves enter. The electromagnetic waves entering the input and output port 12 are guided through the input waveguide 10 and guided to branch waveguide 20 via a first waveguide slot (not shown). The electromagnetic waves guided via the first waveguide slot in the branch waveguide 20 are guided through the branch waveguide 20 and guided to the radiation waveguide 30 via a second waveguide slot (not shown). One or a plurality of first and second waveguide slots may be provided.

The radiation waveguide 30 is formed as a rectangular solid and has a plurality of radiating slots 34 on a slotted surface 32, which forms the rectangular solid. The electromagnetic waves guided via the second waveguide slot are guided through the radiation waveguide 30 and radiated from the radiating slot 34. Hereinafter, the surface opposite to the slotted surface 32 will be referred to as an opposite surface. While the slotted surface 32 is illustrated as being rectangular for the purpose of description, the surface 32 may be circular, elliptical, polygonal, or otherwise. While a total of 32 radiating slots 34 are illustrated as being provided in the slotted surface 32 by way of example, more than or fewer than 32 slots 34 may be provided.

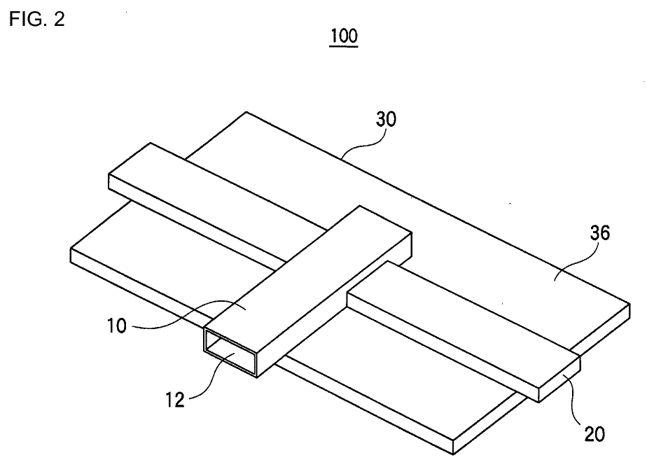

FIG. 2 is a second perspective view showing an exemplary structure of the slot antenna 100 of FIG. 1. FIG. 2 shows the structure on the backside of the slotted surface 32 of the slot antenna 100 shown in FIG. 1. The input waveguide 10, the branch waveguide 20, and the radiation waveguide 30 are provided so as to be in contact with each other. The input waveguide 10 and the branch waveguide 20 are provided on the opposite surface 36 of the radiation waveguide 30 so as to extend across each other and form a cross shape. Since the input waveguide 10 is higher than the branch waveguide 20 as shown, parts of the branch waveguide 20 are embedded in the input waveguide 10. The input waveguide 10 and the branch waveguide 20 may overlap each other so as to form a T shape instead of a cross shape.

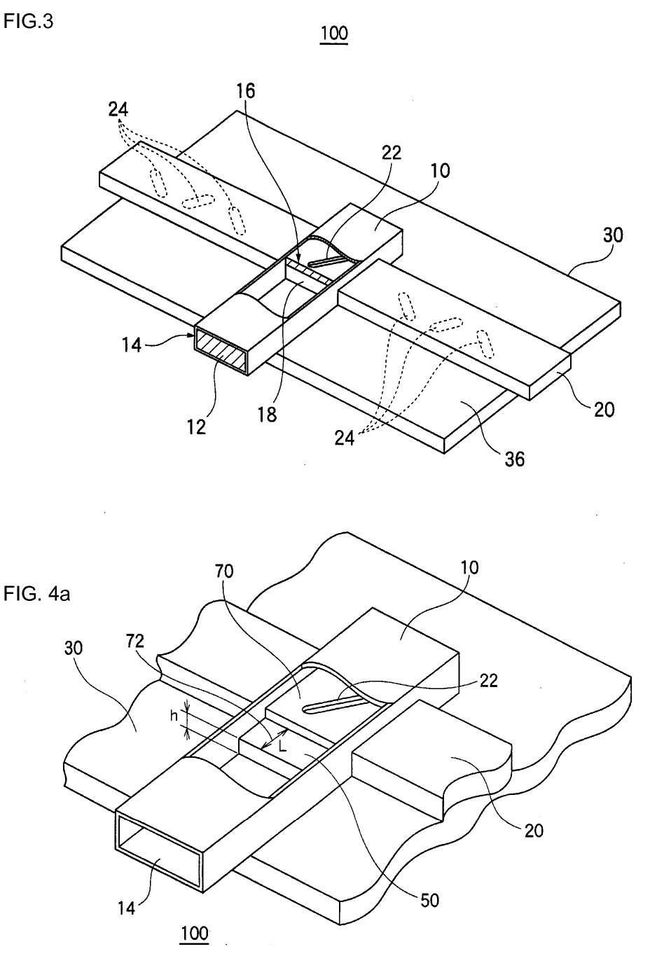

FIG. 3 is a third perspective view schematically showing the slot antenna 100 of FIG. 2. FIG. 3 shows the interior of the input waveguide 10 of the slot antenna shown in FIG. 2. The input waveguide 10 is coupled to the opposite surface 36 of the radiation waveguide 30. The electromagnetic waves entering the input and output port 12 are guided to the branch waveguide 20 via a first waveguide slot 22 provided in the branch waveguide 20. Second waveguide slots 24 indicated by broken lines are provided in the branch waveguide 20. The electromagnetic waves are guided to the radiation waveguide 30 via the second waveguide slots 24. The phantom plane at the input and output port 12 indicated by diagonal lines will be referred to as an entrance aperture plane 14.

As mentioned before, parts of the branch waveguide 20 are embedded in the input waveguide 10. In other words, parts of the branch waveguide 20 are located in the input waveguide 10. As illustrated, parts of the branch waveguide 20 are used as a step forming a stairway in the input waveguide 10. In other words, the breadth of the guiding channel in the input waveguide 10 is narrowed by a stairway structure from the input aperture plane 14 toward a coupling plane. Of the surfaces forming the stairway, the surface parallel with the entrance aperture plane 14 will be referred to as a step surface 18 for the purpose of description. A phantom aperture plane above the step surface and indicated by diagonal lines will be referred to as a step difference aperture plane 16.

To facilitate the design of the input waveguide 10, the area of the entrance aperture plane 14 is assumed to be fixed. Therefore, impedance matching is achieved by adjusting the impedance at the step difference aperture plane 16. The amplitude of the impedance at the step difference aperture plane 16 varies in accordance with the area of the step difference aperture plane 16. The phase of the impedance varies in accordance with the distance between the entrance aperture plane 14 and the step difference aperture plane 16. Accordingly, the impedance at the entrance aperture plane 14 and the impedance at the coupling plane are matched by adjusting the area of the step difference aperture plane 16 and the distance between the entrance aperture plane 14 and the step difference aperture plane 16. Reflected electromagnetic waves entering the entrance aperture plane 14 are reduced accordingly.

Impedance matching is achieved according to the following steps. First, the impedance at the entrance aperture plane 14 is measured and the impedance at the step difference aperture plane 16 is then measured. Impedance may be calculated using a simulation instead of being measured. If the impedance at the aperture and the impedance at the coupling plane as determined do not match, the impedance at the entrance aperture plane 14 or the impedance at the step difference aperture plane 16 is adjusted by changing the area of the step difference aperture plane 16.

More specifically, the amplitude of the impedance at the step difference aperture plane 16 is adjusted by adjusting the height of the branch waveguide 20. By increasing the height of the branch waveguide 20, the area of the step difference aperture plane 16 is decreased so that the amplitude of the impedance is increased. Conversely, by decreasing the height of the branch waveguide 20, the area of the step difference aperture plane 16 is increased so that the amplitude of the impedance is decreased. Further, by adjusting the distance between the entrance aperture plane 14 and the step difference aperture plane 16, the amount of change in the phase of electromagnetic waves in the waveguide, i.e., the phase of the impedance at the step difference aperture plane 16, is adjusted. In this way, impedance matching is achieved efficiently. Instead of adjusting the height of the branch waveguide 20, the height of the input waveguide 10 may be adjusted.

Variations of the embodiment of the present invention will now be presented. An overview of the slot antenna 100 according to the variations will be given. The slot antenna 100 according to the variations differs from the slot antenna 100 of the embodiment in that a step 50 is provided in the input waveguide 10. The step 50 is provided so as to form a stairway. By adjusting the size of the step 50, the impedance at the step difference aperture plane is adjusted so that impedance matching is achieved accordingly. By adjusting the height h and the length L of the step 50, the impedance at the step difference aperture plane of the step 50 is adjusted. The step 50 may be formed of iron, aluminum, or the like. Therefore, impedance matching is achieved flexibly without affecting the cost.

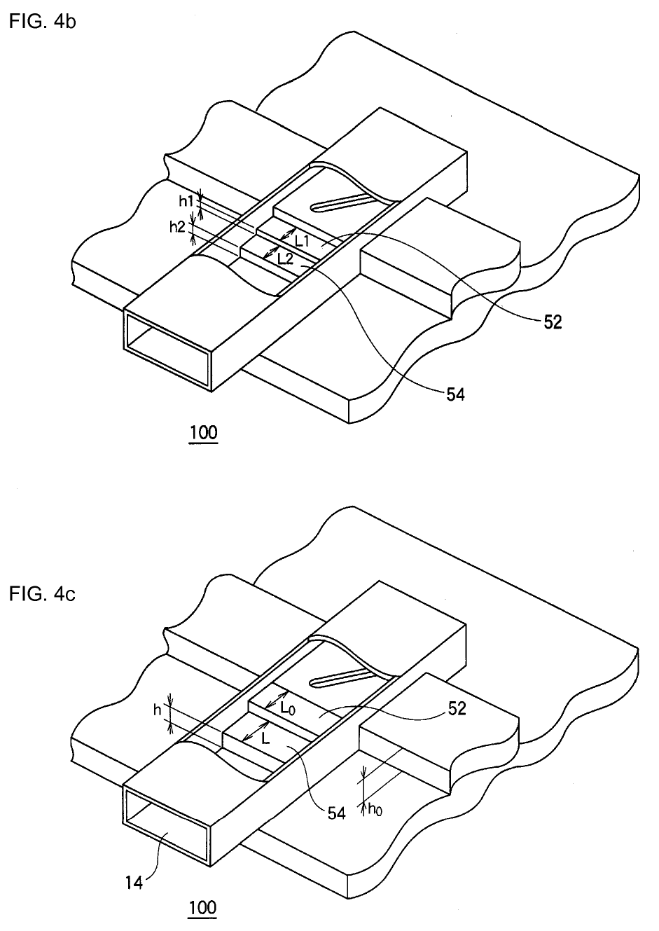

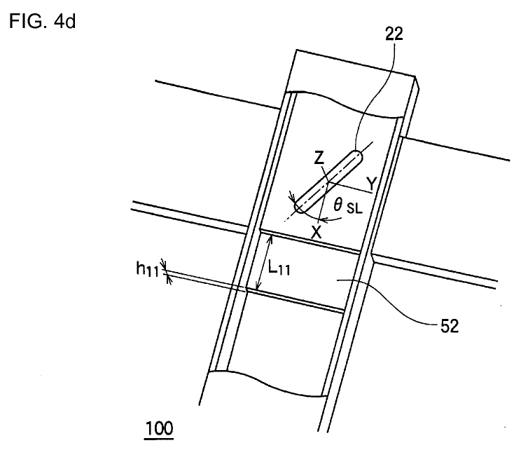

A description will now be given of an exemplary structure according to the variations. Elements identical or corresponding to those in the embodiment described above are denoted by the same numerals so that the description thereof is omitted. FIG. 4A is a first perspective view schematically showing the internal structure of the slot antenna 100 according to the variation of the present invention.

The step 50 is provided in the input waveguide 10. The step 50 is contact with the branch waveguide 20 in the input waveguide 10 and is provided such that the branch waveguide 20 and the step 50 form a stairway going up from the entrance aperture plane 14 toward the end face. The height of the step 50 is less than that of the branch waveguide 20. Of the surfaces parallel with the entrance aperture plane 14 and forming the steps, the surface of the topmost step will be referred to as a first step surface 70 and the surface of the second step will be referred to as a second step surface 72. Of the phantom aperture planes parallel with the entrance aperture plane 14, the plane above the floor of the input waveguide will be referred to as a first step difference aperture plane and the plane above the step will be referred to as a second step difference aperture plane. Of the aperture planes parallel with the entrance aperture plane 14, the aperture plane at the contact interface between the branch waveguide 20 and the first step 52 will be referred to as a zeroth step difference aperture plane.

The impedance at the first step difference aperture plane 60 is adjusted by adjusting the height h and the length L of the step 50, as in the embodiment. Since impedance matching is achieved by adjusting the height h and the length L of the step 50 and without adjusting the height of the branch waveguide 20, the input waveguide 10 and the branch waveguide 20 are easier to design so that the cost is reduced. It will be appreciated by those skilled in the art that, since the step 50 may be formed of iron, aluminum, or the like, adjustment of the height h of the step 50 is easy and does not affect the cost.

FIG. 4B is a second perspective view schematically showing the internal structure of the slot antenna 100 according to a variation of the present invention. The slot antenna 100 shown in FIG. 4B is formed such that two steps including a first step 52 and a second step 54 are formed in the input waveguide 10 of the slot antenna 100 shown in FIG. 4A. The first step 52 is provided so as to be in contact with the branch waveguide 20 in the input waveguide 10. The second step 54 is provided so as to be in contact with the first step 52. The height of the first step 52 is less than that of the branch waveguide 20. The height of the second step 54 is less than that of the first step 52. The first and second steps 52 and 54 may be formed of iron, aluminum, or the like.

By providing a plurality of steps, the amplitude of the impedance at the aperture plane above the step is adjusted more flexibly. By adjusting the distance L1 and distance L2 of the first step 52 and the second step 54, respectively, the phase of the impedance is adjusted more flexibly. The adjusting the height h1 and height h2 of the first step 52 and the second step 54, respectively, the amplitude of the impedance at the respective step difference aperture planes is adjusted. As described, more flexible impedance adjustment is possible in the antenna 100 shown in FIG. 4B by adjusting the four parameters including h1, h2, L1, and L2 and will be particularly suitable when the frequency of electromagnetic waves is high.

FIG. 4C is a third perspective view schematically showing the internal structure of the slot antenna 100 according to a variation of the present invention. The slot antenna 100 shown in FIG. 4C is configured such that, of the two steps including the first step 52 and the second step 54 provided in the waveguide 10 of the slot antenna 100 shown in FIG. 4B, the height of the first step 52 is equal the height of the branch waveguide 20. In other words, a step difference is not created between the branch waveguide 20 and the first step 52 in the input waveguide 10 of the slot antenna 100. The waveguide 20 and the step 52 form an integral plane.

Given that the impedance at the zeroth step difference aperture plane is given by Z=R0+jXA, the length of the depth of the first step 52 is extended to L0 so that the reactance XA of the impedance becomes 0. This will also allow the impedance at the first step difference aperture plane to be given by Z=Rc+j0. By providing the second step 54 for impedance alteration and adjusting the height h and the length L thereof, impedance matching as viewed from the entrance aperture plane 14 is achieved.

Given that the impedance at the entrance aperture plane 14 is given by Rb, the impedance Rtr of the second step difference aperture plane is given by

Rtr=√(Rb/Rc)

In this case, the length L is given by λg/4, where λ denotes a wavelength in the waveguide. The optimal dimensions will be exactly determined by computer simulation or measurements and could be different from theoretically determined dimensions.

FIG. 4D is a fourth perspective view schematically showing the internal structure of the slot antenna 100 according to a variation of the present invention. FIG. 4D shows that impedance matching is achieved by adjusting the angle of inclination θsL of the first waveguide slot 22 and adjusting the height h11 and length L11 of the first step 52 provided in the input waveguide 10 instead of providing the second step 54 shown in FIG. 4C having the height h0 and length L0 in the input waveguide 10. In other words, the number of steps provided in the input waveguide 10 is decreased by modifying the arrangement of the slot. As compared with the input waveguide 10 shown in FIG. 4C, the dimensions of the first step 52 provided inside is decreased so that the flexibility of design is improved. The optimal angle of inclination and dimensions will be determined by computer simulation or measurements.

As described, according to the embodiment, reflected waves are reduced by achieving impedance matching with respect to the aperture plane by providing a step in the waveguide for impedance matching. This will also turn the energy of entering waves into the energy of radiated waves efficiently. The impedance at the step difference aperture plane 16 is adjusted by adjusting the height of the branch waveguide 20 or the height of the input waveguide 10. Impedance matching may also be achieved in a flexible manner by using one or a plurality of steps. The embodiment may be suitably used in radar systems or radio frequency sensors using a resonant linear slot array antenna, a resonant rectangular slot antenna array, or a resonant circular slot antenna array.

By providing the input waveguide 10 and the branch waveguide 20 on the backside of the input waveguide 10 as three-dimensional structures, the antenna area is reduced and the gain per unit area is increased.

Described above is a description based on an embodiment. The embodiment is intended to be illustrative only and it will be obvious to those skilled in the art that various modifications to constituting elements and processes could be developed and that such modifications are also within the scope of the present invention.

In the embodiment, the slot antenna including the input waveguide 10, the branch waveguide 20, and the radiation waveguide 30 is described. Alternatively, the branch waveguide may not be provided. Electromagnetic waves may be radiated from the input waveguide 10 by providing radiating slots in the input waveguide 10. The input waveguide 10, the branch waveguide 20, and the radiation waveguide 30 may be resonant linear slot arrays. Further, three or more steps may be provided. The number of steps may be determined according to the desired frequency characteristic and the size of slot array antenna. The same advantage as described above is also available according to the variations.

### INDUSTRIAL APPLICABILITY

According to the present invention, a slot antenna in which impedance matching is achieved using a simple structure is provided.

1. A slot antenna comprising:
a radiation waveguide operative to radiate electromagnetic waves from a slot provided in a flush surface thereof; and
an input waveguide coupled at one end to a surface opposite to the flush surface, receiving entering electromagnetic waves through an aperture separate from the coupling end, and having a slot for guiding the entering electromagnetic waves to the radiation waveguide, wherein
the height of the input waveguide is narrowed from the aperture toward the coupling end by a stairway structure, and the step difference and the shape of the slot of the stairway structure are adjusted so that the impedance at the aperture and the impedance at the coupling end match.

2. The slot antenna according to claim 1, wherein
the stairway structure is formed of a plurality of steps, and the length of each of the plurality of steps from an end facing the aperture toward the coupling end is adjusted so that the impedance at the aperture and the impedance at the coupling end match.

3. The slot antenna according to claim 1, further comprising:
a branch waveguide lying between the radiation waveguide and the input waveguide and operative to guide electromagnetic waves entering the input waveguide to the radiation waveguide, wherein
the step difference of the stairway structure in the input waveguide is formed by the height of the branch waveguide.

4. The slot antenna according to claim 2, further comprising:
a branch waveguide lying between the radiation waveguide and the input waveguide and operative to guide electromagnetic waves entering the input waveguide to the radiation
the step difference of the stairway structure in the input waveguide is formed by the height of the branch waveguide.
